(19) United States
(12) Patent Application Publication
(10) Pub. No.: US 2013/0321543 A1
(43) Pub. Date: Dec. 5, 2013

(54) PRINTING METHOD AND PRINTING APPARATUS

(71) Applicant: Sony Corporation, Tokyo (JP)

(72) Inventor: Masanobu Tanaka, Kanagawa (JP)

(73) Assignee: Sony Corporation, Tokyo (JP)

(21) Appl. No.: 13/898,546

(22) Filed: May 21, 2013

(30) Foreign Application Priority Data
Jun. 1, 2012 (JP) 2012-125681

(51) Int. Cl. B41J 11/00

(52) U.S. Cl. CPC B41J 11/0015
USPC 347/102

(57) ABSTRACT

A printing method includes: performing a first process that applies first processing to one or a plurality of flat-shaped blankets; and performing a second process that applies second processing to the one or the plurality of blankets to which the first processing has been applied. The second processing is applied in parallel with the first processing applied to another one or plurality of flat-shaped blankets in the first process.

### BACKGROUND

The technology relates to a printing method using a blanket, such as an offset printing method, for example, and a printing apparatus using this printing method.

Offset printing methods have been receiving attention as high-definition printing methods, and may be performed as follows, for example. First, ink is applied onto a blanket containing silicone resin etc., and a plate having a projection section is pressed against the blanket. Then, of the ink on the blanket, a part in contact with the projection section of the plate is removed, and a predetermined pattern is thereby formed on the blanket. This patterned ink on the blanket is transferred to a transferred member, so that offset printing is performed.

This series of processing steps in offset printing is performed while a roll around which the blanket is wound is rotated (see, for example, Japanese Patent No. 3689536). In other words, the blanket is fixed to the roll, and all the processing steps are performed on this single roll. Meanwhile, a method using a flat-shaped blanket has been also proposed (see, for example, Japanese Unexamined Patent Application Publication No. 2008-311463).

### SUMMARY

In such printing using a blanket, the number of times that a series of processing steps is repeated during a predetermined period of time, namely, the number of times that processing of the blanket is performed, is desired to be increased.

It is desirable to provide a printing method and a printing apparatus, in which throughput is improved by increasing the number of times that processing of blanket is performed.

According to an embodiment of the technology, there is provided a printing method including: performing a first process that applies first processing to one or a plurality of flat-shaped blankets; and performing a second process that applies second processing to the one or the plurality of blankets to which the first processing has been applied, the second processing being applied in parallel with the first processing applied to another one or plurality of flat-shaped blankets in the first process.

According to an embodiment of the technology, there is provided a printing apparatus including: a printing execution section including a first processing section and a second processing section, the first processing section applying first processing to one or a plurality of flat-shaped blankets, and the second processing section applying second processing to the one or the plurality of blankets to which the first processing has been applied; and a control section configured to operate the first processing section and the second processing section to cause the first processing and the second processing to be performed in parallel.

In the printing method and the printing apparatus according to the above-described embodiments of the technology, the flat-shaped blankets are used and thus, it is easy to move the blankets. In other words, the one or the plurality of blankets is/are moved after the first processing, and subjected to the second processing at a location different from that of the first processing. This makes it possible to perform the first processing and the second processing in parallel, in the printing method and the printing apparatus according to the above-described embodiments of the technology.

According to the printing method and the printing apparatus in the above-described embodiments of the technology, since the first processing and the second processing are performed in parallel, throughput is improvable by increasing the number of times that the blankets are processed during a certain period of time.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to describe the principles of the technology.

FIG. 1 is a diagram illustrating a configuration of a printing apparatus according to an embodiment of the technology.

FIG. 2 is a cross-sectional diagram used to describe a coating section illustrated in FIG. 1.

FIG. 3 is a cross-sectional diagram used to describe a first drying section illustrated in FIG. 1.

FIG. 4 is a cross-sectional diagram used to describe a reverse section illustrated in FIG. 1.

FIG. 5 is a cross-sectional diagram used to describe a second drying section illustrated in FIG. 1.

FIG. 6 is a cross-sectional diagram used to describe a transfer section illustrated in FIG. 1.

FIG. 7A is a cross-sectional diagram illustrating an example of a way of causing contact between a blanket and a plate depicted in FIG. 4.

FIG. 7B is a cross-sectional diagram illustrating an example of a way of fixing the blanket to a stage depicted in FIG. 7A, which is another example different from that depicted in FIG. 7A.

FIG. 7C is a cross-sectional diagram illustrating another example of the way of causing contact between the blanket and the plate depicted in FIG. 4.

FIG. 8A is a cross-sectional diagram illustrating an example of a way of separating the blanket and the plate depicted in FIG. 7A.

FIG. 8B is a cross-sectional diagram illustrating an example of a way of separating the blanket and the plate depicted in FIG. 7C.

FIG. 9A is a cross-sectional diagram illustrating an example of a way of causing contact between the blanket and a substrate depicted in FIG. 6.

FIG. 9B is a cross-sectional diagram illustrating an example of a way of fixing the blanket to a stage depicted in FIG. 9A, which is another example different from that depicted in FIG. 9A.

FIG. 9C is a cross-sectional diagram illustrating another example of the way of causing contact between the blanket and the substrate depicted in FIG. 6.

FIG. 10A is a cross-sectional diagram illustrating an example of an alignment method used when causing contact between the substrate and the blanket.

FIG. 10B is a diagram used to describe the alignment method illustrated in FIG. 10A.

FIG. 11A is a side view of a main part, illustrating a printing method using a roll.

FIG. 11B is a side view illustrating a process following FIG. 11A.

FIG. 11C is a side view illustrating a process following FIG. 11B.

FIG. 12 is a diagram used to describe throughput when a single flat-shaped blanket is used.

FIG. 13 is a diagram used to describe throughput when the printing apparatus illustrated in FIG. 1 is used.

FIG. 14 is a cross-sectional diagram illustrating a configuration of a display unit manufactured using the printing apparatus depicted in FIG. 1.

FIG. 15 is a diagram illustrating an overall configuration of the display unit depicted in FIG. 14.

FIG. 16 is a circuit diagram illustrating an example of a pixel driving circuit depicted in FIG. 15.

FIG. 17 is a perspective diagram illustrating an appearance of an application example 1.

FIGS. 18A and 18B are perspective diagrams each illustrating an appearance of an application example 2, namely, FIG. 18A illustrates the appearance when viewed from front, and FIG. 18B illustrates the appearance when viewed from back.

FIG. 19 is a perspective diagram illustrating an appearance of an application example 3.

FIG. 20 is a perspective diagram illustrating an appearance of an application example 4.

FIGS. 21A to 21G are views of an application example 5, namely, a front view in an open state, a side view in the open state, a front view in a closed state, a left-side view, a right-side view, a top view, and a bottom view, respectively.

### DETAILED DESCRIPTION

An embodiment of the technology will be described in detail with reference to the drawings. It is to be noted that the description will be provided in the following order.

1. Embodiment: a printing apparatus (an example in which a plurality of processing steps are performed in parallel)
2. Application examples: display units (each example in which a part of a display unit is formed using the above-mentioned printing apparatus)

### Embodiment

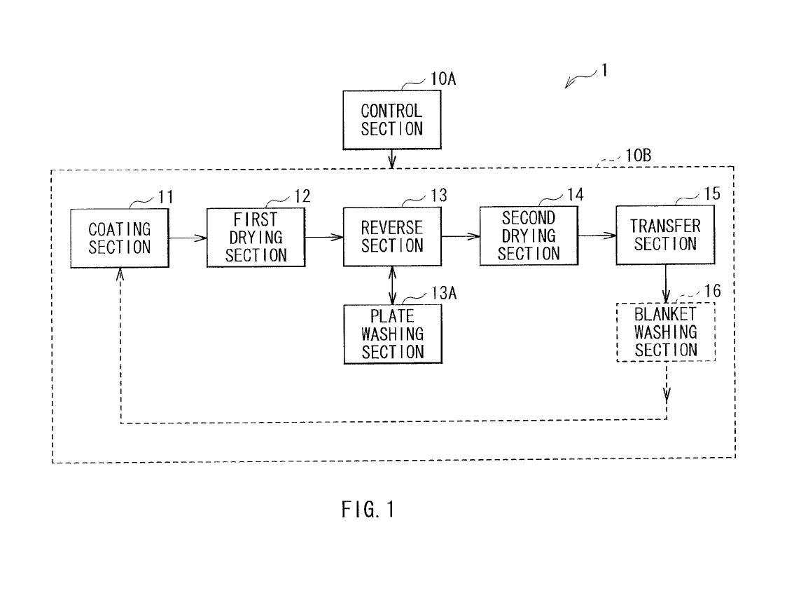

FIG. 1 illustrates a configuration of a printing apparatus (a printing apparatus 1) according to an embodiment of the technology. The printing apparatus 1 includes a control section 10A and a printing execution section 10B. The printing execution section 10B includes a coating section 11, a first drying section 12, a reverse section 13, a second drying section 14, and a transfer section 15. In this printing apparatus 1, offset printing is performed such that a flat-shaped blanket (a blanket 31 described later) is conveyed to each of processing sections (i.e. the coating section 11, the first drying section 12, the reverse section 13, the second drying section 14, and the transfer section 15) of the printing execution section 10B sequentially, based on signals outputted by the control section 10A.

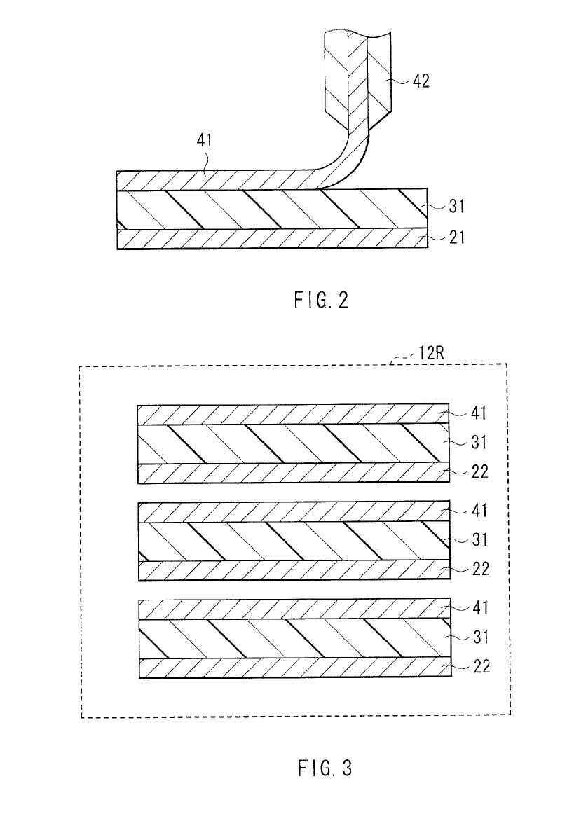

In the coating section 11, processing of applying ink 41 to the flat-shaped blanket 31 sequentially is performed as illustrated in FIG. 2. In this coating section 11, for example, spin coating may be used, and the ink 41 discharged from an opening of a coating head 42 is applied to an entire surface of the blanket 31 fixed to a stage 21. In the coating section 11, other coating method such as a spraying method, a CAP coating method, a slit coating method, an LB (Langmuir-Blodgett) film-formation method, and an ink-jet method, for example, may be used instead of the spin coating.

The blanket 31 may include, for example, a PDMS (polydimethylsiloxane) layer having a thickness of about 1 μm to about 5000 μm, on a hard base material. The hard base material may be made of a glass plate or a metal plate, and may have a thickness of about 10 μm to about 500 μm. The ink 41 is applied to contact the PDMS layer. Providing the PDMS layer, which is flexible, on the hard base material makes it possible to reduce transfer pressure while increasing precision in a plane direction.

The ink 41 contains a solvent and a solute. Adjusting the viscosity of the ink 41 to about 5 mPas or less, for example, allows the ink 41 having a film thickness of about 5 μm or less to be applied to the blanket 31. The solute of the ink 41 may be selected as appropriate, depending on a printed material. Examples of this solute may include an organic conductive material, an organic insulating material, an organic semiconductor material, an organic luminescent material, and metal microparticles (metal nanoparticles). The solvent of the ink 41 causes the solute to disperse or dissolve. Usable examples of this solvent may include linear alkanes such as pentane, hexane, and heptane, cycloalkanes such as cyclopentane and cyclohexane, and ethers such as ethyl methyl ether, diethyl ether, and tetrahydrofuran.

In the first drying section 12, the ink 41 formed on the blanket 31 by the coating section 11 is dried. As described above, it is possible to reduce the film thickness of the ink 41 on the blanket 31 by lowering the viscosity of the ink 41. However, when a plate (a plate 51 described later) is brought into contact with the ink 41 in a state of low viscosity, a shape (a pattern) may be disturbed, or cobwebbing due to stickiness of the ink 41 may occur. Providing the first drying section 12 causes the solvent of the ink 41 to vaporize, thereby making it possible to increase the viscosity. The pattern may also be disturbed when the ink 41 is dried excessively for a long time. Therefore, drying time is adjusted depending on the solvent and the solute in use. The drying time may be, for example, about 30 seconds to about 90 seconds.

Preferably, the first drying section 12 may be configured to contain a plurality of blankets 31, and may be configured to send each of the blankets 31 that has reached an optimum dry state to the reverse section 13 described later. A drying process is relatively longer than other processes, but it is possible to prevent a throughput decrease attributable to this drying process, by allowing the first drying section 12 to contain the plurality of blankets 31. Further, preferably, the dry state of the ink 41 may be controllable in the first drying section 12. As illustrated in FIG. 3, for example, the dry state of the ink 41 may be controlled by arranging the blankets 31 in a first drying room 12R in an atmosphere of dry nitrogen, or may be controlled by heating a stage 22 on which each of the blankets 31 is placed. The dry state of the ink 41 may be adjusted by both of the first drying room 12R and the stage 22.

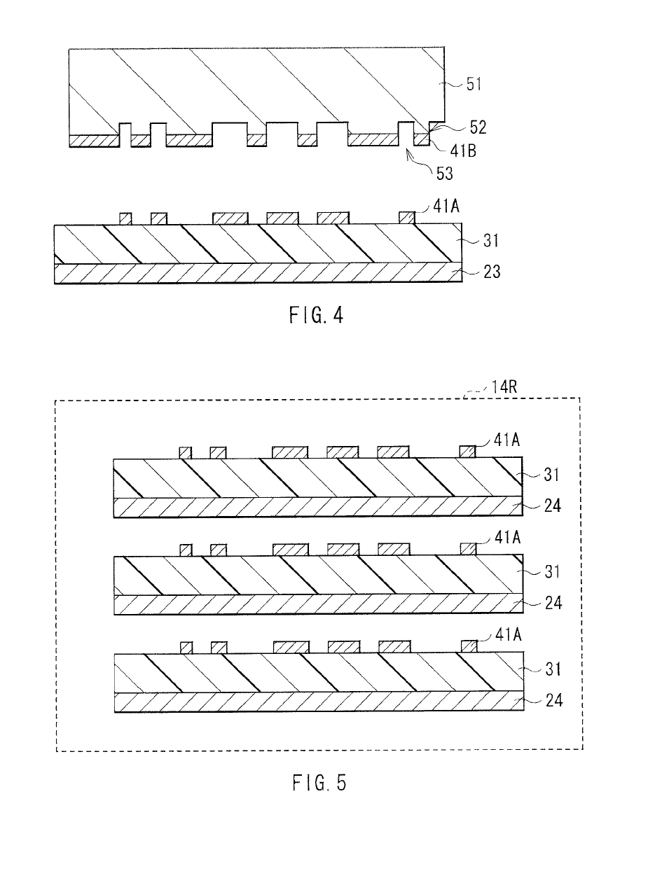

In the reverse section 13, a pattern (ink 41A) of the ink 41 is formed on the blanket 31, by using the plate 51 having a projection section 52 and a depression section 53, as illustrated in FIG. 4. This pattern formation may be performed as follows. After the plate 51 is brought into contact with the ink 41 (the blanket 31) dried for a predetermined period of time in the first drying section 12, the plate 51 and the ink 41 are separated. As a result, the ink 41 (the ink 41B) that has contacted the projection section 52 is removed from the blanket 31, and the ink 41A having a pattern of the depression section 53 is formed on the blanket 31.

The plate 51 may be configured using, for example, quartz, glass, resin, metal, or the like. A pattern made up of the projection section 52 and the depression section 53 on a surface of the plate 51 may be formed by, for example, photolithography, etching, or the like.

The printing apparatus 1 has a plate washing section 13A for restoration of the plate 51 to which the ink 41B has been attached in the reverse section 13 (FIG. 1). In the plate washing section 13A, the plate 51 is washed and then dried (a third drying process), so that the surface condition of the plate 51 is constantly returned to the same state even when a series of printing processing is performed repeatedly. In the printing apparatus 1, preferably, a plurality of plates 51 may be used. When washing and drying of the plate 51 are insufficient, printing quality may be reduced, and it takes, for example, from about tens of seconds to about a few minutes to carry out sufficient washing and drying of the plate 51. Use of the plurality of plates 51 allows, while one of the plates 51 is in the plate washing section 13A, different one of the plates 51 to be used in the reverse section 13. Therefore, it is possible to prevent a decrease in throughput due to washing and drying of the plate 51. Preferably, the plate washing section 13A may be allowed to contain a plurality of plates 51. In the plate washing section 13A, a plurality of plates 51 to which the ink 41B is attached may be washed together and dried together after being contained, or a plurality of restored plates 51 may be contained.

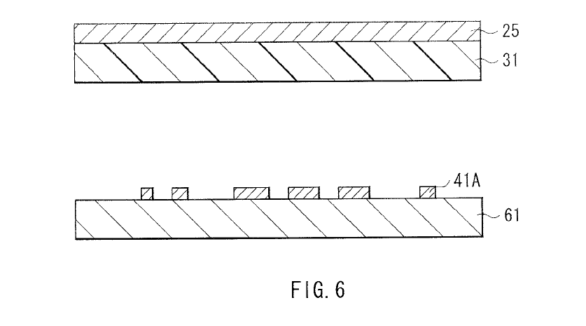

In the second drying section 14, the ink 41A is subjected to drying processing for a predetermined period of time. Drying time may be, for example, about 60 seconds to about 300 seconds. In this second drying section 14, in a manner similar to the above-described first drying section 12, pattern disturbance and cobwebbing which occur when the ink 41A is transferred to the transferred member (for example, a substrate 61 in FIG. 6, which will be described later) are prevented by adjusting the viscosity of the ink 41A. Preferably, in a manner similar to the first drying section 12, the second drying section 14 may be provided with a second drying room 14R in an atmosphere of dry nitrogen and/or a heatable stage 24 for control of the dry state (FIG. 5). At the second drying section 14, for example, the blanket 31 fixed to the stage 24 may be contained in the second drying room 14R, and the ink 41A is dried. Preferably, in a manner similar to the first drying section 12, the second drying section 14 may be also allowed to contain a plurality of blankets 31. Each of the blankets 31 which have reached an optimum dry state is sent out to the transfer section 15 described later.

In the transfer section 15, the ink 41A dried in the second drying section 14 is transferred to the transferred member (the substrate 61) as illustrated in FIG. 6. Specifically, after the blanket 31 fixed to a stage 25 is caused to face the substrate 61 and the ink 41A is caused to contact the substrate 61, the blanket 31 and the substrate 61 are separated. The substrate 61 may be selected as appropriate according to the ink 41 (a printed material), which may be, for example, silicon, synthetic quarts, glass, metal, resin, a resin film, or the like.

The printing apparatus 1 has a blanket washing section 16 for restoration of the blanket 31. In the blanket 31 that has passed through the coating section 11, the first drying section 12, the reverse section 13, the second drying section 14, and the transfer section 15, the solvent of the ink 41 is likely to be contained, or a part of the ink 41A is likely to remain due to poor transfer. In addition, dust adsorbed by the plate 51 and the substrate 61 is likely to be attached to the blanket 31. In the blanket washing section 16, the blanket 31 thus tainted is dried after being washed (a fourth drying process), thereby maintaining the surface condition of the blanket 31 in a constant state close to the initial state, for example. Therefore, durability of the blanket 31 improves, making it possible to reduce the cost while maintaining the printing quality even when a series of printing processing is repeated. It may take, for example, about 30 seconds to about 600 seconds to restore the blanket 31. Washing the blanket 31 may be performed as necessary, and only drying may be carried out without washing. Preferably, a plurality of blankets 31 may be contained in the blanket washing section 16. In the blanket washing section 16, the plurality of blankets 31 may be washed (dried) together after these blankets 31 conveyed from the transfer section 15 are contained, or a plurality of restored blankets 31 may be contained. The blanket 31 restored in the blanket washing section 16 is moved to the coating section 11 and used again.

The control section 10A controls the operation of each of the processing sections (i.e. the coating section 11, the first drying section 12, the reverse section 13, the plate washing section 13A, the second drying section 14, the transfer section 15, and the blanket washing section 16) of the printing execution section 10B, so that at least two kinds of processing (first processing and second processing) in the printing execution section 10B are carried out in parallel. In the present embodiment, all the processing sections of the printing execution section 10B are caused to operate together by this control section 10A. Specifically, the first processing of one embodiment of the technology is coating, while the second processing of one embodiment of the technology includes drying, reverse, and plate restoration in the first drying section 12, as well as transfer and blanket restoration in the second drying section 14. As will be described later in detail, this makes it possible to improve throughput as compared with a printing apparatus using a roll.

The offset printing to the substrate 61 by the printing apparatus 1 may be performed as follows, for example.

First, the ink 41 is applied to the blanket 31 by the coating section 11 (FIG. 2). Next, the blanket 31 to which the ink 41 has been applied is moved to the first drying section 12, and dried for a predetermined period of time while the dry state may be controlled by the first drying room 12R and the stage 22 (FIG. 3), for example. The blanket 31 is then conveyed from the first drying section 12 to the reverse section 13, and the plate 51 is brought into contact with the ink 41.

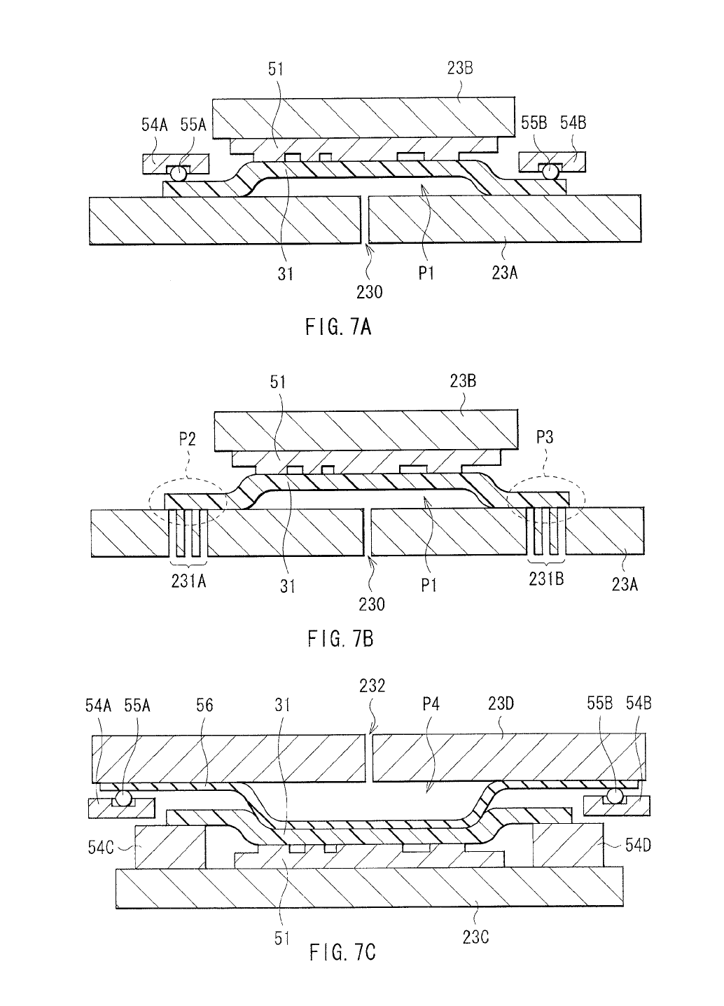

The ink 41 (the blanket 31) and the plate 51 may be brought into contact with each other by, for example, pressurization and compression using compressed gas pressurization, as illustrated in FIG. 7A. In this process, the blanket 31 and the plate 51 are fixed to stages 23A and 23B, respectively, so that the ink 41 faces the projection section 52 and the depression section 53. The stage 23A on the blanket 31 side has a through-hole 230 near a center. This through-hole 230 functions as a vacuum vent and a compressed-gas inlet port. The circumference of the blanket 31 is mechanically fixed by O rings 55A and 55B as well as fixing frames 54A and 54B. When compressed gas is injected through the through-hole 230, the blanket 31 is pushed out from the back-face (a face opposite to a face to which the ink 41 is applied) side, bringing the ink 41 into contact with the plate 51. At this moment, a space P1 between the stage 23A and the blanket 31 is sealed up.

The blanket 31 may be fixed to the stage 23A by using through-holes 231A and 231B (FIG. 7B), instead of the O rings 55A and 55B as well as the fixing frames 54A and 54B. The through-holes 231A and 231B are provided at positions in the stage 23A, the positions facing the circumference of the blanket 31. As indicated by P2 and P3 in FIG. 7B, the blanket 31 is fixed to the stage 23A by vacuum adsorption to these through-hole 231A and 231B. It is possible to fix the blanket 31 to the stage 23A in such a simple way using the fixing frames 54A and 54B or the vacuum adsorption as described above, or other simply way. In addition, this blanket 31 is allowed to be removed from the stage 23A easily.

As illustrated in FIG. 7C, the blanket 31 and the plate 51 may be brought into contact with each other through use of an elastic film 56 which is flexible and expandable. The elastic film 56 is fixed to a stage 23D having a through-hole 232, and the plate 51 is fixed to a stage 23C. The stage 23D and the stage 23C face each other. The elastic film 56 is mechanically fixed to the stage 23D by the O rings 55A and 55B as well as the fixing frames 54A and 54B. The blanket 31 is disposed between the plate 51 and the elastic film 56, by using fixing frames 54C and 54D on the stage 23C. When compressed gas is injected through the through-hole 230, the blanket 31 is pushed toward the plate 51 side together with the elastic film 56, bringing the ink 41 into contact with the plate 51. At this moment, a space P4 between the stage 23D and the elastic film 56 is sealed up. The distance between the blanket 31 and the plate 51 fixed to the stages (the stages 23A, 23B, 23C, and 23D) may be, for example, about 1 μm to about 1 mm. Transfer pressure may be controlled to be a low pressure of about 0.1 kPa to about 100 kPa, for example, and also to be uniform in in-plane of the blanket 31. This makes it possible to prevent the pattern of the ink 41 from being crushed.

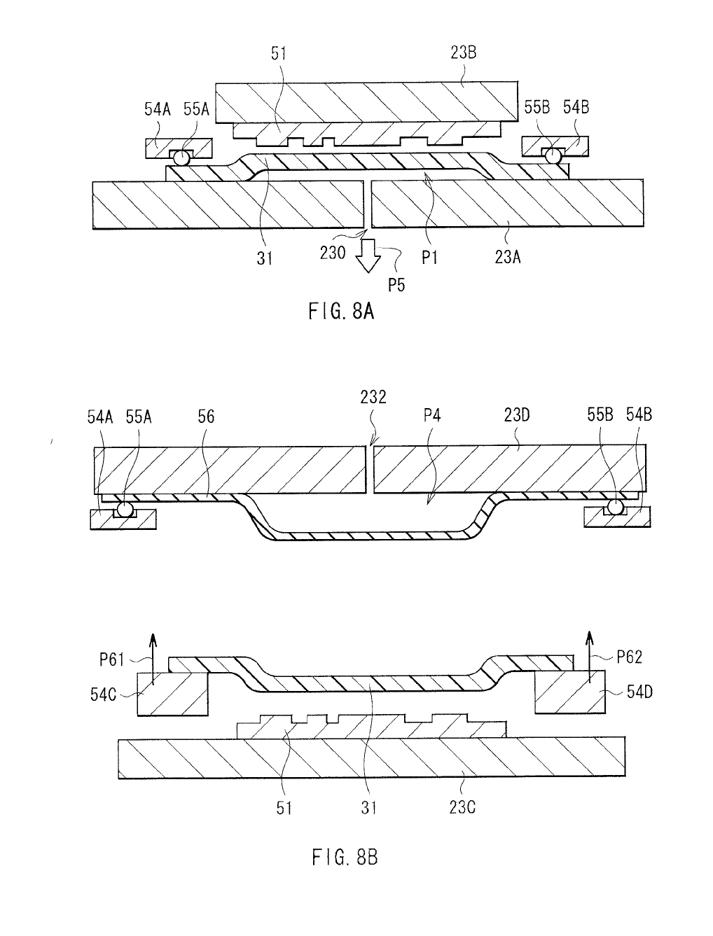

The plate 51 and the blanket 31 are separated after being brought into contact with each other. As a result, the ink 41A of the pattern corresponding to the depression section 53 of the plate 51 is formed on the blanket 31. The blanket 31 and the plate 51 may be separated by vacuum evacuation (an arrow P5) in the space P1 through the through-hole 230 of the stage 23A, as illustrated in FIG. 8A, for example. This separation may be mechanically performed by lifting the circumference (the fixing frames 54A and 54B) of the blanket 31 from the stage 23C, as illustrated in FIG. 8B.

The blanket 31 on which the ink 41A is formed in the reverse section 13 is moved to the second drying section 14, and dried for a predetermined period of time. On the other hand, the plate 51 to which the ink 41B is attached is conveyed to the plate washing section 13A and restored. The plate washing section 13A may have a so-called foliage-type cleaning device which processes washing work one by one, for example, and a cleaning solvent such as an organic solvent, an acid, and an alkali may be selected depending on the type of the ink 41. After being washed, the plate 51 may be dried by heating, for example. The drying of the plate 51 may also be air drying, vacuum drying, or drying in a low humidity environment. This restored plate 51 is moved to the reverse section 13 and used again. The restored plate 51 may be returned to the reverse section 13, after being held at the plate washing section 13A for a predetermined period of time.

After being dried in the second drying section 14, the blanket 31 is moved to the transfer section 15. In the transfer section 15, the blanket 31 (the ink 41A) and the substrate 61 are separated after being brought into contact with each other, so that the ink 41A is transferred to the substrate 61.

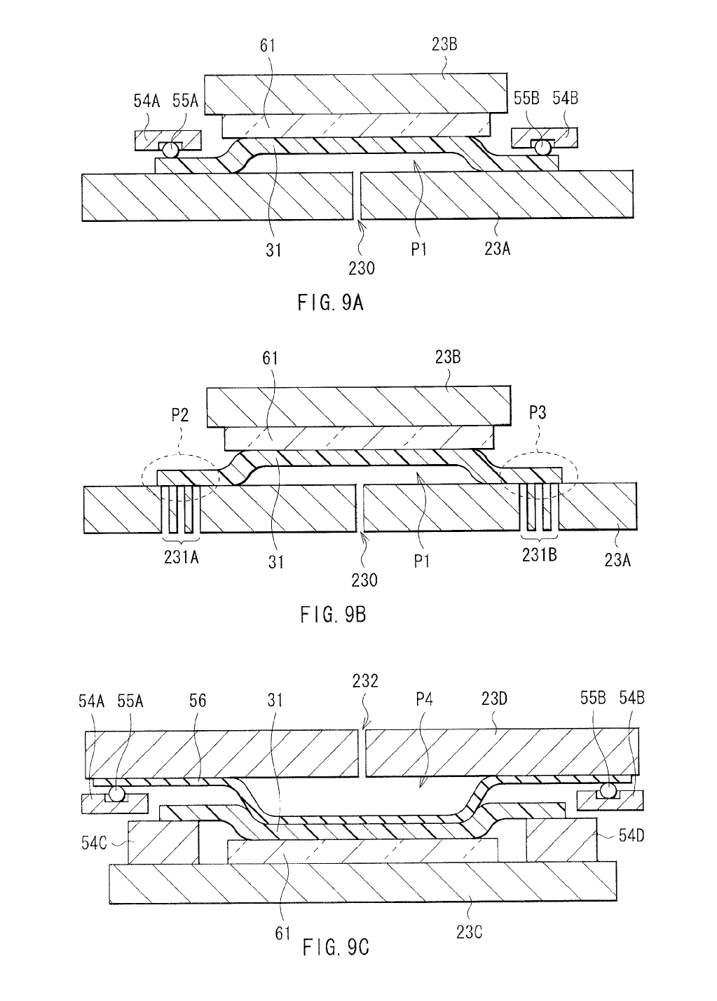

The blanket 31 may be brought into contact with the substrate 61 by pressurization and compression, for example. The blanket 31 and the substrate 61 are fixed to the stage 23A and the stage 23B, respectively, so that the ink 41A faces the substrate 61, as illustrated in FIG. 9A. In a manner similar to that illustrated in FIG. 7A, the circumference of the blanket 31 is mechanically fixed by the O rings 55A and 55B as well as the fixing frames 54A and 54B. When compressed gas is injected through the through-hole 230 of the stage 23A, the ink 41A comes in contact with the substrate 61. In a manner similar to that described with reference to FIG. 7B and FIG. 7C, the blanket 31 may be fixed to the stage 23A by using the through-holes 231A and 231B (FIG. 9B), or the blanket 31 and the substrate 61 may be brought into contact with each other through use of the elastic film 56 (FIG. 9C).

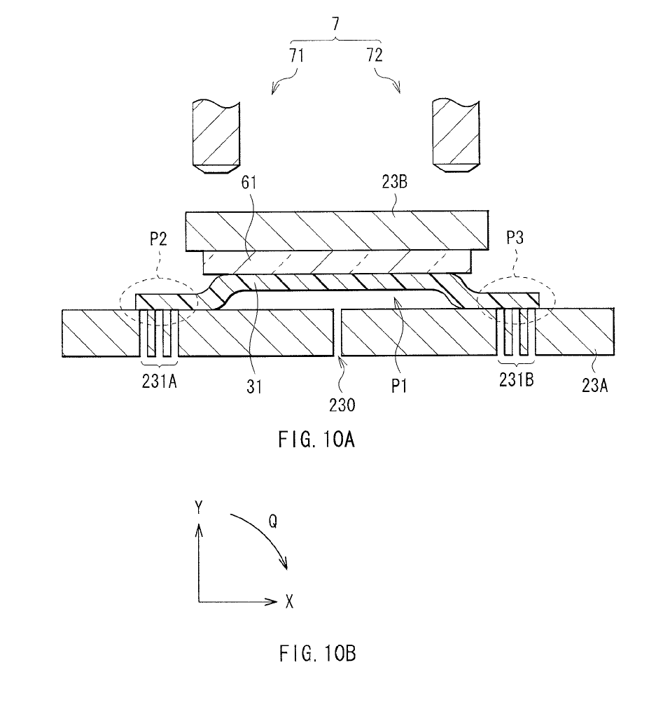

The blanket 31 and the substrate 61 may be aligned with each other by using an alignment mark, when being brought into contact with each other. The alignment mark may be provided for each of the blanket 31 and the substrate 61, for example. This pair of alignment marks may be checked with a microscope 7 (71, 72) for alignment as illustrated in FIG. 10A, for example, and X, Y, and θ coordinates may be adjusted (FIG. 10B). A mechanism of controlling the X, Y, and θ coordinates may be, for example, provided in the stage 23A, the stage 23B, or both (or the stage 23C, the stage 23D, or both). The alignment mark on the blanket 31 side may be formed by the ink 41A, or may be formed at the blanket 31 beforehand. When being formed at the blanket 31 beforehand, the alignment mark is allowed to be formed on the PDMS layer of the blanket 31 or between the base material and the PDMS layer.

The blanket 31 and the substrate 61 may be separated by vacuum evacuation (FIG. 8A) through the through-hole 230, for example, after being brought into contact with each other. The blanket 31 and the substrate 61 may be mechanically separated by lifting the circumference (the fixing frames 54A and 54B) of the blanket 31 from a stage 23E (FIG. 8B). The substrate 61 to which the ink 41A has been transferred may be conveyed, for example, to the outside of the printing apparatus 1. Alternatively, a part used to house the substrate 61 that has been subjected to the offset printing may be provided within the printing apparatus 1. On the other hand, the blanket 31 separated from the substrate 61 is moved to the blanket washing section 16. In the blanket washing section 16, after the blanket 31 is washed using, for example, a cleaning solvent such as an organic solvent, an acid, and an alkali, this blanket 31 is restored by being dried through heating. The drying of the blanket 31 may also be, for example, vacuum drying or drying in a low humidity environment. The blanket 31 thus restored is moved to the coating section 11 and used again. The blanket 31 may be held at the blanket washing section 16 for a predetermined period of time.

In the printing apparatus 1, the flat-shaped blanket 31 is moved through the coating section 11, the first drying section 12, the reverse section 13, the second drying section 14, and the transfer section 15 in this order, based on signals from the control section 10A, so that the printing on the substrate 61 is performed. The blanket 31 used for this series of processing steps is moved from the transfer section 15 to the blanket washing section 16 and restored, which is then conveyed to the coating section 11 again. Meanwhile, the plate 51 used in the reverse section 13 is restored at the plate washing section 13A and conveyed to the reverse section 13 again. Here, since the flat-shaped blanket 31 is used, it is possible to perform the printing in parts by the above-described plurality of processing sections and moving the blanket 31 through each of the processing sections in order. Therefore, use of the plurality of blankets 31 allows the plurality of processing sections to operate together. This will be described below.

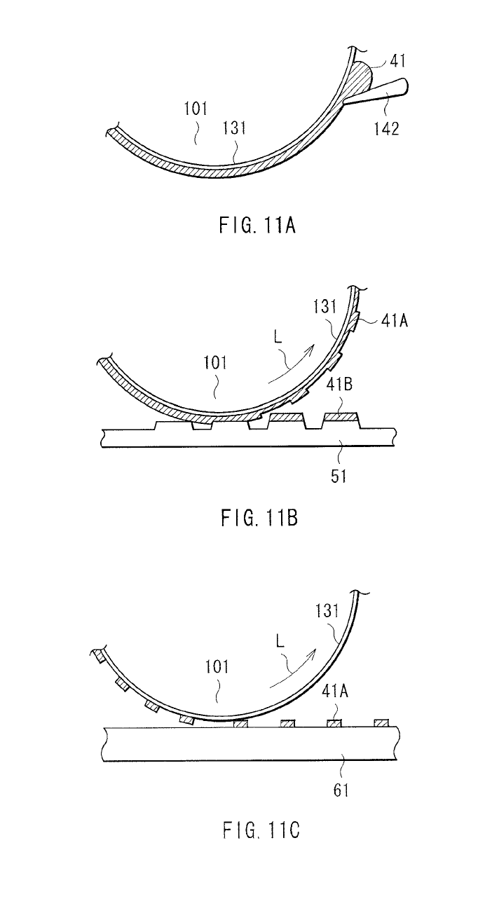

FIG. 11A, FIG. 11B, and FIG. 11C illustrate a printing method using a roll 101. In this printing method using the roll 101, first, a blanket 131 is wound around the roll 101, and fixed firmly. Next, ink 41 is applied to the blanket 131 by a blade unit 142 (FIG. 11A). Subsequently, the ink 41 is brought into contact with a plate 51 while the roll 101 is rotated in an L direction so that a pattern of ink 41A is formed on the blanket 131 (FIG. 11B). The blanket 131 is then brought into contact with a substrate 61 while rotation of the roll 101 is continued, so that the ink 41A is transferred to the substrate 61 (FIG. 11C). Between coating and reverse as well as between the reverse and transfer, it is necessary to dry the ink 41 (or the ink 41A), as with the case described for the printing apparatus 1. After the ink 41A is transferred to the substrate 61, the blanket 131 is dried and restored in a state of being fixed to the roll 101.

In such printing using the roll 101, work of removing the fixed blanket 131 from the roll 101 is complicated, and all the processing steps, namely, the coating (FIG. 11A), the drying of the ink after the coating, the reverse (FIG. 11B), the drying of the ink after the reverse, the transfer (FIG. 11C), and the restoration of the blanket 131 are performed using the single roll 101. In other words, use of the roll 101 prevents the printing from being performed in parts by a plurality of processing sections. Further, it is difficult to prepare a plurality of rolls 101, because the roll 101 is expected to perform a plurality of processing steps with high precision and thus is expensive. Furthermore, although it is conceivable to increase the area of the blanket 131 thereby increasing a printed area, this increase in the area of the blanket 131 extends the time it takes to apply the ink 41, which readily causes coating irregularity. In particular, when an easily-evaporating solvent is used for the ink 41 to shorten the drying time between the coating and the reverse as well as between the reverse and the transfer, significant coating irregularity occurs.

In the printing using the roll 101, an increase in the drying time of the ink 41 or the restoration time of the blanket 131 or the plate 51 leads directly to an increase in the time necessary for one printing, which reduces throughput. Besides, when the washing and drying in the restoration of the blanket 131 are insufficient, the surface condition of the blanket 131 changes, which is likely to affect wettability and transferability. Moreover, since the one plate 51 is used for the one roll 101, it is difficult to use a plurality of plates 51.

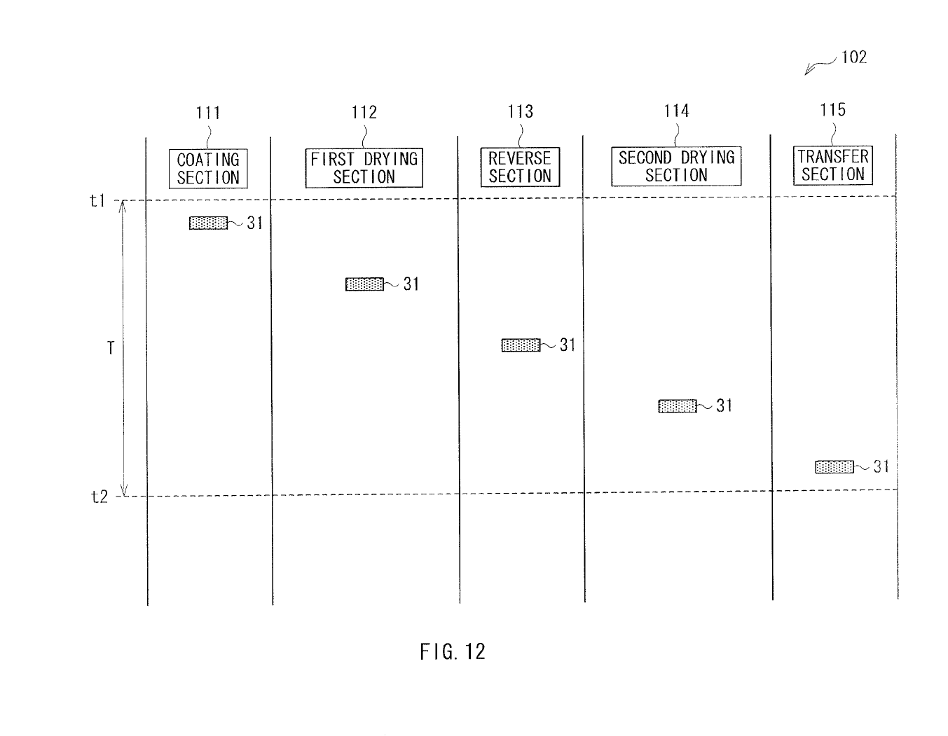

To address such a method using the roll 101, a method of printing using a flat-shaped blanket has been proposed. A flat-shaped blanket 31 is allowed to be fixed to a stage through use of vacuum adsorption, fixing frames (see FIG. 7A and FIG. 7B), etc., and thus is easily attachable and detachable to and from the stage. This makes it possible to perform printing by moving the blanket 31 through each of processing sections sequentially. FIG. 12 schematically illustrates how the printing is performed by moving the one flat-shaped blanket 31 through a coating section 111, a first drying section 112, a reverse section 113, a second drying section 114, and a transfer section 115 during a period of time (printing time T) from time t1 to time t2 in a printing apparatus 102. In the printing apparatus 102, however, the blanket 31 in use is a single blanket, preventing a plurality of processing sections from being operated together.

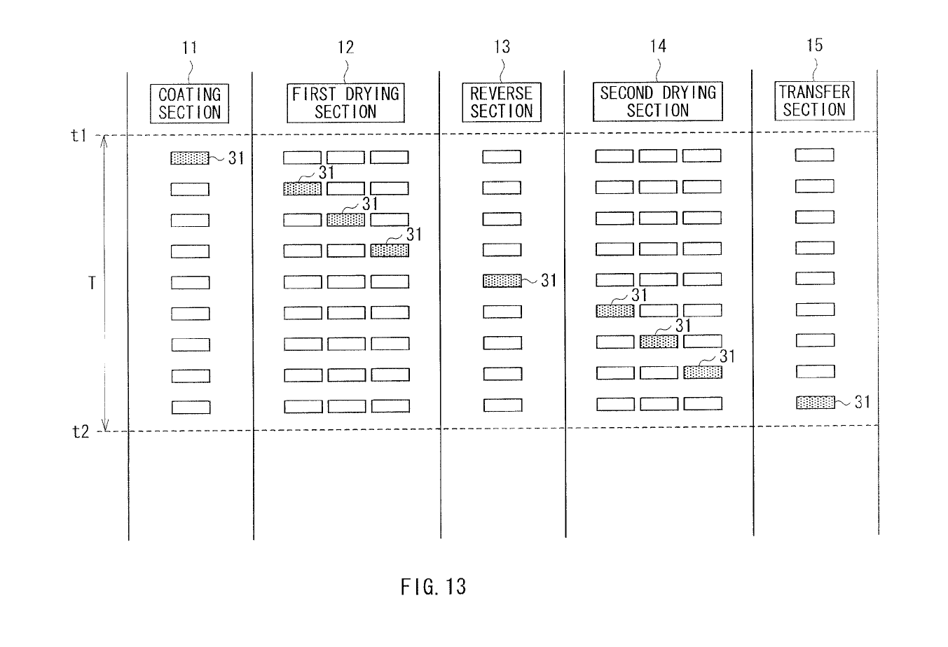

In the printing apparatus 1, in contrast, it is possible to perform a plurality of processing steps in parallel, because the plurality of flat-shaped blankets 31 are used. Specifically, in the printing apparatus 1, the plurality of blankets 31 (nine in FIG. 13) are subjected to coating processing (the coating section 11), drying processing (the first drying section 12), reverse processing (the reverse section 13), drying processing (the second drying section 14), and transfer processing (the transfer section 15) during printing time T, as illustrated in FIG. 13. For example, in parallel with the drying processing applied to the blanket 31 (the blanket 31 in black illustrated in FIG. 13) in the first drying section 12, the coating processing is applied to another blanket 31 (the blanket 31 in white illustrated in FIG. 13). Therefore, it is possible to improve the throughput, as compared with the case where the roll 101 is used and the printing apparatus 102 using the single blanket 31.

In particular, it takes a longer time to perform the drying processing in each of the first drying section 12 and the second drying section 14 than those in other processes. Therefore, it is possible to improve the throughput effectively, by performing these drying processes in parallel with other processes following the drying processes. In other words, the throughput is improved further by providing the first processing of one embodiment of the technology as the drying in the first drying section 12 or the drying in the second drying section 14, and sequentially moving each of the blankets 31 that has been dried for a predetermined period of time to the next process (a reverse process or a transfer process). This also applies to the drying processing in each of the plate washing section 13A and the blanket washing section 16. In addition, the first drying section 12 and the second drying section 14 as well as the plate washing section 13A and the blanket washing section 16 each contain the plurality of blankets 31 and/or the plurality of plates 51 and therefore, printing work smoothly progresses, which further improves the throughput.

In the case of the printing using the roll 101, although coating irregularity is less likely to occur when a less volatile solvent is used for the ink 41, the throughput is reduced by an increase in the drying time. This also applies to the printing apparatus 102. Namely, when the time during which the blanket 31 is present in each of the first drying section 12 and the second drying section 14 increases, the printing time T also increases, which reduces the throughput. In contrast, in the printing apparatus 1, since the first drying section 12 and the second drying section 14 operate together with other processing sections, the solvent of the ink 41 is freely selectable. This suppresses coating irregularity of the ink 41 in the coating section 11, making it possible to increase the printed area.

In addition, since the plate washing section 13A and the blanket washing section 16 operate together with other processing sections, it is possible to wash and dry the plate 51 or the blanket 31 sufficiently. Therefore, the surface state of each of the plate 51 and the blanket 31 is kept constant, which allows an improvement in printing quality.

Furthermore, since the blanket 31 is readily attachable and detachable to and from the stage (for example, the stages 23A and 23C), maintenance is also simplified.

In the present embodiment as described above, since the flat-shaped blankets 31 are used, a series of work necessary for printing is allowed to be performed in parts by the plurality of processing sections. This makes it possible to perform a plurality of processing steps in parallel, allowing an improvement in the throughput.

### APPLICATION EXAMPLES

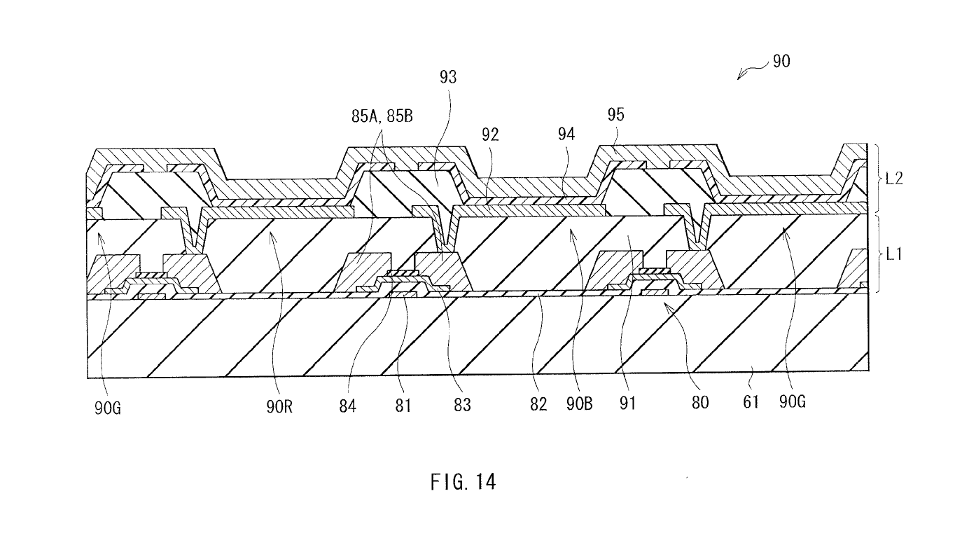

A part of a display unit (a display unit 90) illustrated in FIG. 14, for example, may be manufactured using the printing apparatus 1 of the above-described embodiment. This display unit 90 may be a self-luminous-type display unit having a plurality of organic light-emitting devices 90R, 90G, and 90B. The display unit 90 has a pixel-driving-circuit formed layer L1, a light-emission-device formed layer L2, and a counter substrate (not illustrated) in this order on the substrate 61. The light-emission-device formed layer L2 includes the organic light-emitting devices 90R, 90G, and 90B.

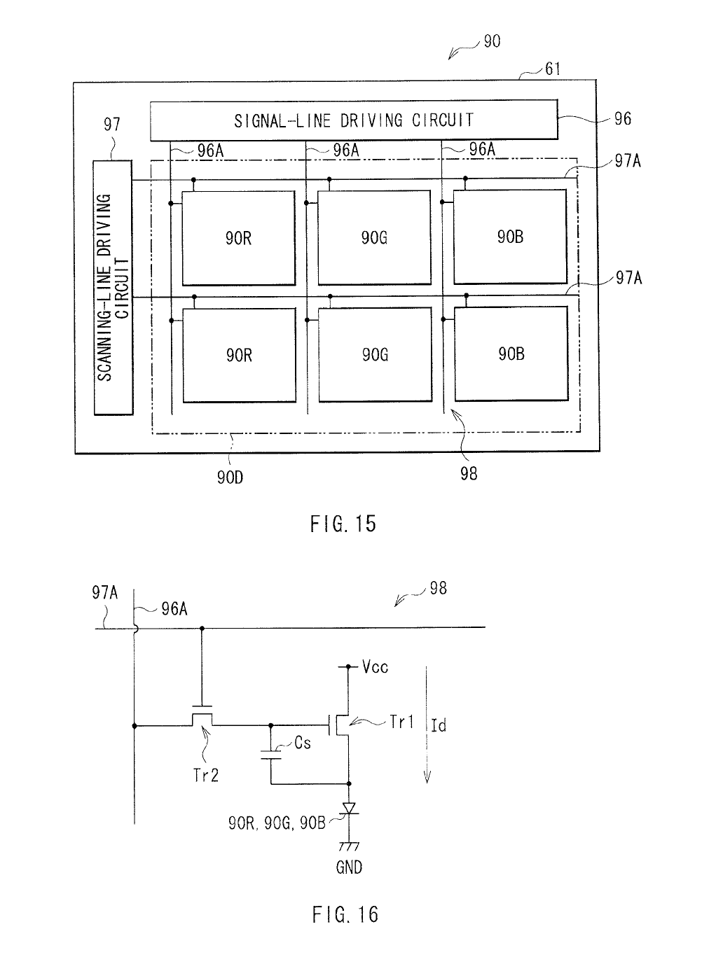

FIG. 15 illustrates an overall configuration of the display unit 90. The display unit 90 has a display region 90D on the substrate 61, and is used as an ultrathin organic light-emitting color display device. Around the display region 90D on the substrate 61, for example, a signal-line driving circuit 96 and a scanning-line driving circuit 97 which are drivers for image display may be provided.

In the display region 90D, the plurality of organic light-emitting devices 90R, 90G, and 90B arranged two-dimensionally in a matrix and a pixel driving circuit 98 used to drive these devices are formed. In the pixel driving circuit 98, a plurality of signal lines 96A are arranged in a column direction, and a plurality of scanning lines 97A are arranged in a row direction. Each of the organic light-emitting devices 90R, 90G, and 90B is provided to correspond to an intersection between each of the signal lines 96A and each of the scanning lines 97A. Each of the signal lines 96A and each of the scanning lines 97A are connected to the signal-line driving circuit 96 and the scanning-line driving circuit 97, respectively.

The signal-line driving circuit 96 supplies each of the organic light-emitting devices 90R, 90G, and 90B selected through the signal line 96A with a signal voltage of an image signal corresponding to luminance information supplied from a signal supply source (not illustrated). The signal voltage is applied from the signal-line driving circuit 96 to the signal line 96A.

The scanning-line driving circuit 97 includes a shift register etc. which sequentially perform shifting (transfer) of a start pulse in synchronization with an inputted clock pulse. When writing an image signal to the organic light-emitting devices 90R, 90G, and 90B, the scanning-line driving circuit 97 scans these devices row by row, and sequentially supplies a scanning signal to each of the scanning lines 97A. The scanning signal is supplied from the scanning-line driving circuit 97 to the scanning line 97A.

The pixel driving circuit 98 is provided in a layer between the substrate 61 and the organic light-emitting devices 90R, 90G, and 90B, namely, the pixel-driving-circuit formed layer L1. This pixel driving circuit 98 may be an active drive circuit having a drive transistor Tr1, a write transistor Tr2, a retention capacitor Cs therebetween, and the organic light-emitting devices 90R, 90G, and 90B as illustrated in FIG. 16.

Next, a detailed configuration including elements such as the pixel-driving-circuit formed layer L1 and the light-emission-device formed layer L2 will be described with reference to FIG. 14.

A transistor 80 (the drive transistor Tr1 and the write transistor Tr2) of the pixel driving circuit 98 is formed in the pixel-driving-circuit formed layer L1, and further, the signal lines 96A and the scanning lines 97A are also embedded therein. Specifically, the transistor 80 and a flattening layer 91 are provided in this order on the substrate 61. The transistor 80 may be, for example, a bottom-gate-type transistor having a gate electrode 81, a gate insulating film 82, and a semiconductor film 83 in this order from the substrate 61 side. Source-drain electrodes 85A and 85B are electrically connected to the semiconductor film 83. A channel region of the semiconductor film 83 is covered with a channel protective film 84, and the flattening layer 91 is provided on this channel protective film 84 as well as the source-drain electrodes 85A and 85B. The flattening layer 91 is provided to flatten mainly the surface of the pixel-driving-circuit formed layer L1, and is formed of, for example, an insulating resin material such as polyimide.

The light-emission-device formed layer L2 is provided with the organic light-emitting devices 90R, 90G, and 90B, a device separating film 93, and a sealing layer (not illustrated) used to cover them. In each of the organic light-emitting devices 90R, 90G, and 90B, a first electrode 92 serving as an anode electrode, an organic layer 94 including a luminous layer, and a second electrode 95 serving as a cathode electrode are laminated in this order from the substrate 61 side. The organic layer 94 may have, for example, a hole injection layer, a hole transport layer, the luminous layer, and an electron transport layer in this order from the first electrode 92 side. This luminous layer may be provided for each device (FIG. 14) or provided as a common to each device (not illustrated). Here, this luminous layer of the organic layer 64 may be manufactured using the printing apparatus 1. Layers other than the luminous layer may be provided as necessary. The device separating film 93 is made of an insulating material, and provided to separate the organic light-emitting devices 90R, 90G, and 90B from each other and define a light emission region of each of the organic light-emitting devices 90R, 90G, and 90B. The organic light-emitting devices 90R, 90G, and 90B are covered with a protective layer (not illustrated), and the counter substrate (not illustrated) is provided on this protective layer with an adhesive layer (not illustrated) interposed therebetween. The counter substrate may have, for example, a color filter corresponding to the organic light-emitting devices 90R, 90G, and 90B.

This display unit 90 may be manufactured as follows, for example.

First, the pixel driving circuit 98 including the transistor 80 and the flattening layer 91 are formed on the substrate 61 which may be made of glass. The pixel-driving-circuit formed layer L1 is thereby formed.

Next, a titanium film and an aluminum alloy film may be formed by, for example, sputtering, which may be then molded into a predetermined shape by, for example, a photolithographic method and dry etching, so that the first electrode 92 is formed. Subsequently, a photosensitive insulating material such as polyimide is applied onto the flattening layer 91 and the first electrode 92, and then exposure and development by photolithography are performed, so that the device separating film 93 is formed.

After the device separating film 93 is formed, the luminous layer of the organic layer 94 may be formed using the printing apparatus 1 of the above-described embodiment. The hole injection layer, the hole transport layer, and the electron transport layer of the organic layer 94 may be formed using the printing apparatus 1, or may be formed using a method such as vapor deposition. Next, the second electrode 95 may be formed on the organic layer 94 by vapor deposition, for example. The light-emission-device formed layer L2 is thereby formed.

A protective film (not illustrated) may be formed on the organic light-emitting devices (organic EL devices) 90R, 90G, and 90B as necessary by, for example, CVD (Chemical Vapor Deposition) or sputtering. Further, the counter substrate (not illustrated) on which the color filter etc. is formed is prepared, and this counter substrate is adhered to the protective film by using the adhesive layer (not illustrated). This completes the display unit 90 illustrated in FIG. 14 to FIG. 16.

The display unit 90 as described above is applicable to display units of electronic apparatus in all fields, which display externally-inputted image signals or internally-generated image signals as still or moving images. The electronic units may include, for example, television receivers, digital cameras, laptop computers, portable terminals such as portable telephones, video cameras, and the like.

### Application Example 1

FIG. 17 illustrates an appearance of a television receiver. This television receiver may have, for example, an image-display screen section 300 that includes a front panel 310 and a filter glass 320. The image-display screen section 300 is configured using the display unit 90.

### Application Example 2

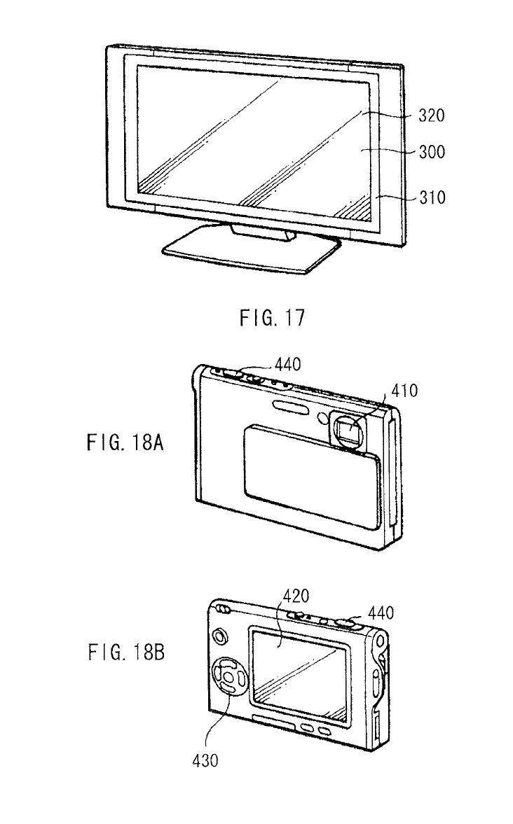

FIGS. 18A and 18B each illustrate an appearance of a digital camera. This digital camera may include, for example, a flash emitting section 410, a display section 420, a menu switch 430, and a shutter release 440. The display section 420 is configured using the display unit 90.

### Application Example 3

FIG. 19 illustrates an appearance of a laptop computer. This laptop computer may include, for example, a main body section 510, a keyboard 520 provided to enter characters and the like, and a display section 530 displaying an image. The display section 530 is configured using the display unit 90.

### Application Example 4

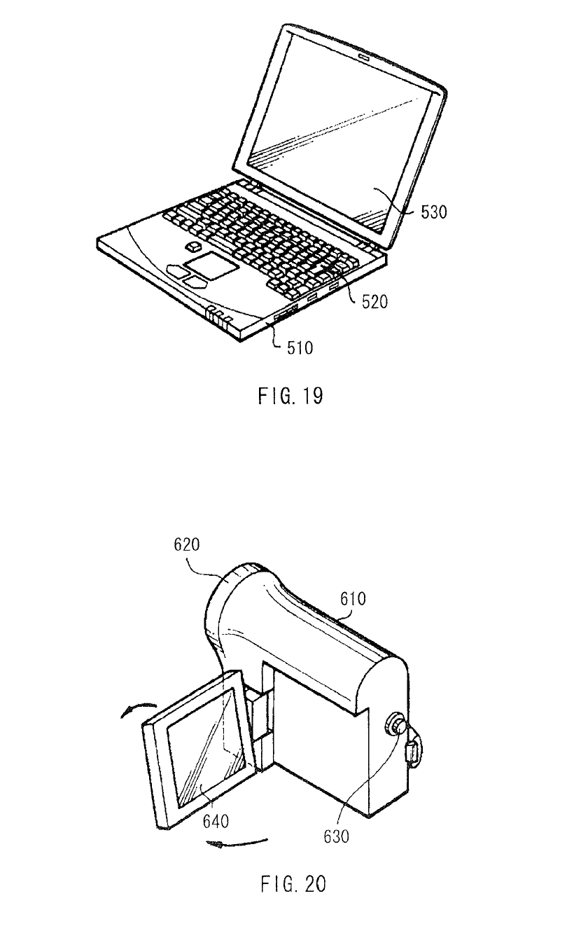

FIG. 20 illustrates an appearance of a video camera. This video camera may include, for example, a main body section 610, a lens 620 disposed on a front face of this main body section 610 to shoot an image of a subject, a start/stop switch 630 used in shooting, and a display section 640. The display section 640 is configured using the display unit 90.

### Application Example 5

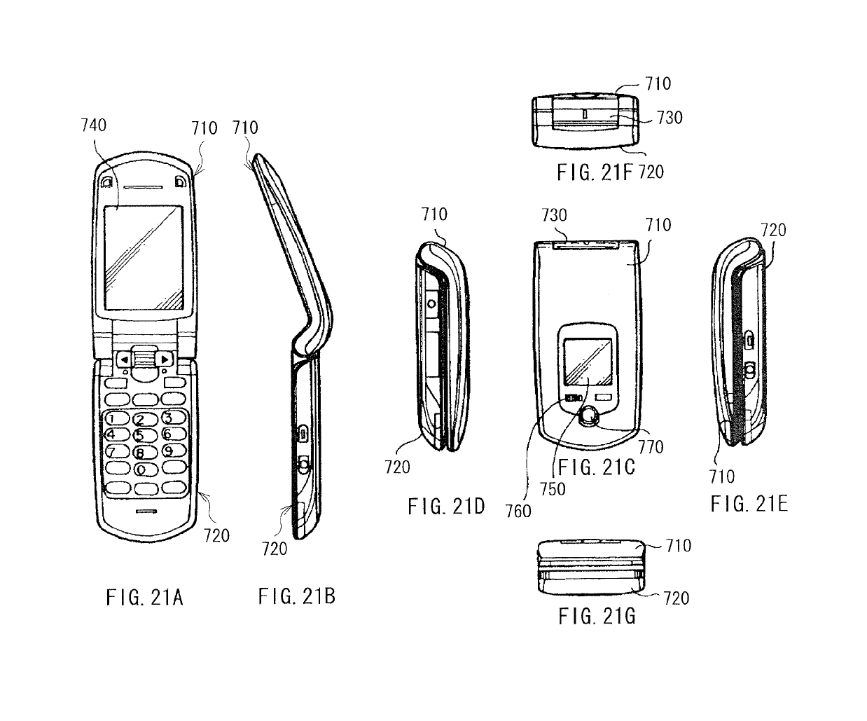

FIGS. 21A to 21G each illustrate an appearance of a portable telephone. This portable telephone may be, for example, a unit in which an upper housing 710 and a lower housing 720 are connected by a coupling section (a hinge section) 730, and may include a display 740, a sub-display 750, a picture light 760, and a camera 770. The display 740 or the sub-display 750 is configured using the display unit 90.

The technology has been described with reference to the example embodiment and the application examples, but is not limited thereto and may be variously modified. For example, in the above-described embodiment, there has been described the printing apparatus 1 in which all the processing sections, namely, the coating section 11, the first drying section 12, the reverse section 13, the plate washing section 13A, the second drying section 14, the transfer section 15, and the blanket washing section 16 operate together. However, operating at least two of the coating section 11, the first drying section 12, the reverse section 13, the second drying section 14, and the transfer section 15 among them together allows an improvement in the throughput.

Further, in the above-described embodiment, the way of fixing the blanket 31 to the stage 23A by using the fixing frames 54A and 54B (FIG. 7A) or the through-holes 231A and 231B (FIG. 7B) has been described. However, the blanket 31 may be fixed in other way.

Furthermore, in the above-described application example, the case where the organic layer 94 (the luminous layer) of the display unit 90 is formed using the printing apparatus 1 has been described. However, other part of the display unit 90, for example, the flattening layer 91, the device separating film 93, or the like may be formed by the printing apparatus 1. In addition, when the semiconductor film 83 of the transistor 80 is configured using an organic semiconductor material, the semiconductor film 83 may be formed using the printing apparatus 1. Alternatively, wiring (for example, the signal lines 96A and the scanning lines 97A) of the pixel driving circuit 98 may be formed through use of ink using metal nanoparticles. It is also possible to form a resist by using the printing apparatus 1.

In addition, for example, the materials and thicknesses, or the film formation methods and film formation conditions described in the embodiment and the application examples are illustrative and not limitative. Other materials and thicknesses, or other film formation methods and film formation conditions may be adopted.

Furthermore, in the above-described application example, the display unit provided with the organic EL devices has been described, but a part of a display unit with any of various kinds of display devices such as an inorganic EL device, a liquid crystal device, and an electrophoretic display device may be formed using the printing apparatus 1.

Furthermore, the technology encompasses any possible combination of some or all of the various embodiments described herein and incorporated herein.

It is possible to achieve at least the following configurations from the above-described example embodiments of the disclosure.

(1) A printing method, including:

performing a first process that applies first processing to one or a plurality of flat-shaped blankets; and

performing a second process that applies second processing to the one or the plurality of blankets to which the first processing has been applied, the second processing being applied in parallel with the first processing applied to another one or plurality of flat-shaped blankets in the first process.

(2) The printing method according to (1), wherein the second process is one of a single process following the first process and a series of processes following the first process.
(3) The printing method according to (2), wherein the first process and the second process are a combination including two or more of:

a coating process that applies ink to the blanket;

a first drying process that dries the ink of the one or the plurality of blankets;

a reverse process that brings a plate having a predetermined pattern into contact with the ink following the first drying process;

a second drying process that dries the ink of the one or the plurality of blankets, after separating the plate from the blanket; and

a transfer process that transfers the ink following the second drying process to a transferred member.

(4) The printing method according to (3), wherein the first process is one of the first drying process and the second drying process.
(5) The printing method according to (4), wherein

the first process is the first drying process, and

the plurality of blankets are dried and are each moved to the reverse process after a lapse of a predetermined period of time, in the first drying process.

(6) The printing method according to (4), wherein

the first process is the second drying process, and

the plurality of blankets are dried and are each moved to the transfer process after a lapse of a predetermined period of time, in the second drying process.

(7) The printing method according to (3), wherein

the first process is the coating process,

the second process includes the first drying process, the reverse process, the second drying process, and the transfer process, and

the coating process, the first drying process, the reverse process, the second drying process, and the transfer process are all performed in parallel.

(8) The printing method according to (7), wherein

the plate includes one or a plurality of plates,

the second process further includes a third drying process that dries the one or the plurality of plates after washing the one or the plurality of plates to which the ink is attached, and

the third drying process is also performed in parallel with the coating process, the first drying process, the reverse process, the second drying process, and the transfer process.

(9) The printing method according to (8), wherein the third drying process is performed in parallel with the coating process, the first drying process, the reverse process, the second drying process, and the transfer process, by using the plurality of plates.
(10) The printing method according to (7), wherein

the second process further includes a fourth drying process that dries the one or the plurality of blankets following the transfer process, and

the fourth drying process is also performed in parallel with the coating process, the first drying process, the reverse process, the second drying process, and the transfer process.

(11) The printing method according to (3), wherein the blanket is fixed to a stage by vacuum adsorption in the reverse process, in the transfer process, or in both of the reverse process and the transfer process.
(12) The printing method according to (3), wherein the blanket is fixed to a stage by an O ring and a fixing frame in the reverse process, in the transfer process, or in both of the reverse process and the transfer process.
(13) A printing apparatus, including:

a printing execution section including a first processing section and a second processing section, the first processing section applying first processing to one or a plurality of flat-shaped blankets, and the second processing section applying second processing to the one or the plurality of blankets to which the first processing has been applied; and

a control section configured to operate the first processing section and the second processing section to cause the first processing and the second processing to be performed in parallel.

The disclosure contains subject matter related to that disclosed in Japanese Priority Patent Application JP 2012-125681 filed in the Japan Patent Office on Jun. 1, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A printing method, comprising:
performing a first process that applies first processing to one or a plurality of flat-shaped blankets; and
performing a second process that applies second processing to the one or the plurality of blankets to which the first processing has been applied, the second processing being applied in parallel with the first processing applied to another one or plurality of flat-shaped blankets in the first process.

2. The printing method according to claim 1, wherein the second process is one of a single process following the first process and a series of processes following the first process.

3. The printing method according to claim 2, wherein the first process and the second process are a combination including two or more of:
a coating process that applies ink to the blanket;
a first drying process that dries the ink of the one or the plurality of blankets;
a reverse process that brings a plate having a predetermined pattern into contact with the ink following the first drying process;
a second drying process that dries the ink of the one or the plurality of blankets, after separating the plate from the blanket; and
a transfer process that transfers the ink following the second drying process to a transferred member.

4. The printing method according to claim 3, wherein the first process is one of the first drying process and the second drying process.

5. The printing method according to claim 4, wherein
the first process is the first drying process, and
the plurality of blankets are dried and are each moved to the reverse process after a lapse of a predetermined period of time, in the first drying process.

6. The printing method according to claim 4, wherein
the first process is the second drying process, and
the plurality of blankets are dried and are each moved to the transfer process after a lapse of a predetermined period of time, in the second drying process.

7. The printing method according to claim 3, wherein
the first process is the coating process,
the second process includes the first drying process, the reverse process, the second drying process, and the transfer process, and
the coating process, the first drying process, the reverse process, the second drying process, and the transfer process are all performed in parallel.

8. The printing method according to claim 7, wherein
the plate includes one or a plurality of plates,
the second process further includes a third drying process that dries the one or the plurality of plates after washing the one or the plurality of plates to which the ink is attached, and
the third drying process is also performed in parallel with the coating process, the first drying process, the reverse process, the second drying process, and the transfer process.

9. The printing method according to claim 8, wherein the third drying process is performed in parallel with the coating process, the first drying process, the reverse process, the second drying process, and the transfer process, by using the plurality of plates.

10. The printing method according to claim 7, wherein
the second process further includes a fourth drying process that dries the one or the plurality of blankets following the transfer process, and
the fourth drying process is also performed in parallel with the coating process, the first drying process, the reverse process, the second drying process, and the transfer process.

11. The printing method according to claim 3, wherein the blanket is fixed to a stage by vacuum adsorption in the reverse process, in the transfer process, or in both of the reverse process and the transfer process.

12. The printing method according to claim 3, wherein the blanket is fixed to a stage by an O ring and a fixing frame in the reverse process, in the transfer process, or in both of the reverse process and the transfer process.

13. A printing apparatus, comprising:
a printing execution section including a first processing section and a second processing section, the first processing section applying first processing to one or a plurality of flat-shaped blankets, and the second processing section applying second processing to the one or the plurality of blankets to which the first processing has been applied; and
a control section configured to operate the first processing section and the second processing section to cause the first processing and the second processing to be performed in parallel.
